(19) United States
(12) Patent Application Publication
(10) Pub. No.: US 2007/0146313 A1
(43) Pub. Date: Jun. 28, 2007

(54) Providing input data

(76) Inventors: Andrew Newman, Enfield (GB); Tania Jane Beagley, Clapham (GB); Stuart Mark Walkington, Hemel Hempstead (GB)

Correspondence Address: HARNESS, DICKEY, & PIERCE, P.L.C, 7700 BONHOMME, STE 400, ST. LOUIS, MO, 63105, US

(21) Appl. No.: 11/601,044

(22) Filed: Nov. 17, 2006

Related U.S. Application Data
(63) Continuation-in-part of application No. 11/355,228, filed on Feb. 15, 2006.

(30) Foreign Application Priority Data
Feb. 17, 2005 (GB) GB 05 03 291.7

(51) Int. Cl. G09G 5/00

(52) U.S. Cl. 345/156

(57) ABSTRACT

Apparatus for covering a portable computer of the type provided with a touch screen as an alternative to a keyboard. A rectangular fabric bag has an opening at one of the smaller ends of the rectangle for receiving the portable computer. The bag includes a fabric surface sensitive to the manual application of pressure, key positions defined on the fabric surface and a control circuit for identifying mechanical interactions to generate output data. The portable computer includes an interface and executable instructions for interpreting said output data. The interface may be a mechanical interface or a radio interface.

### CROSS-REFERENCE TO RELATED APPLICATIONS

This application is filed as a continuation-in-part of U.S. patent application Ser. No. 11/355,228, filed 15 Feb. 2006, which in turn claims priority from United Kingdom Patent Application No. 05 03 291.7, filed 17 Feb. 2005. The disclosures of the above applications are incorporated herein by reference in its entirety as if fully set forth herein.

### FIELD

The present invention relates to apparatus for providing data input, comprising a fabric bag for receiving a portable computer, the fabric bag including a fabric surface sensitive to the manual application of pressure and a control circuit for identifying mechanical interactions to generate output data.

### BACKGROUND

The statements in this section merely provide background information related to the present disclosure and may not constitute prior art.

Data input devices are used with data processing devices. For example, a portable computer may include a keyboard for inputting data into the portable computer.

### SUMMARY

According to an aspect of the present invention, there is provided apparatus that generally includes a rectangular fabric bag with an opening at one of the smaller ends of the rectangle for receiving a portable computer. The bag includes a fabric surface sensitive to the manual application of pressure and having key positions defined thereon. The bag also includes a control circuit for identifying mechanical interactions to generate output data. The portable computer includes a connection interface and executable instructions for interpreting the output data.

The connection interface may be a mechanical interface or a radio interface.

The portable computer may be a tablet PC of the type that is smaller than a notebook PC but larger than a personal organiser.

Further aspects and features of the present disclosure will become apparent from the detailed description provided hereinafter. In addition, any one or more aspects of the present disclosure may be implemented individually or in any combination with any one or more of the other aspects of the present disclosure. It should be understood that the detailed description and specific examples, while indicating exemplary embodiments of the present disclosure, are intended for purposes of illustration only and are not intended to limit the scope of the present disclosure.

### DRAWINGS

The drawings described herein are for illustration purposes only and are not intended to limit the scope of the present disclosure in any way.

FIG. 1 shows a manually operable fabric keyboard;

FIG. 2 shows the inner workings of the fabric keyboard shown in FIG. 1;

FIG. 3 shows details of an electronic processing device of the type shown in FIG. 2;

FIG. 4 shows a protective covering for a data processing device, in the form of a fabric bag;

FIG. 5 shows a portable computer partially removed from the fabric bag of FIG. 4;

FIG. 6 shows the portable computer of FIG. 5 in further detail, in use;

FIG. 7 illustrates the use of the fabric bag of FIG. 4, to generate input data for the operation of the portable computer of FIGS. 5 and 6;

FIG. 8 illustrates a radio environment;

FIG. 9 shows a fabric bag including a manually operable fabric controller;

FIG. 10 illustrates the use of the fabric bag of FIG. 9 to generate input data for the operation of a portable computer;

FIGS. 11 and 12 illustrate features of the fabric bag of FIG. 9.

### DETAILED DESCRIPTION

The following description is merely exemplary in nature and is in no way intended to limit the present disclosure, application, or uses.

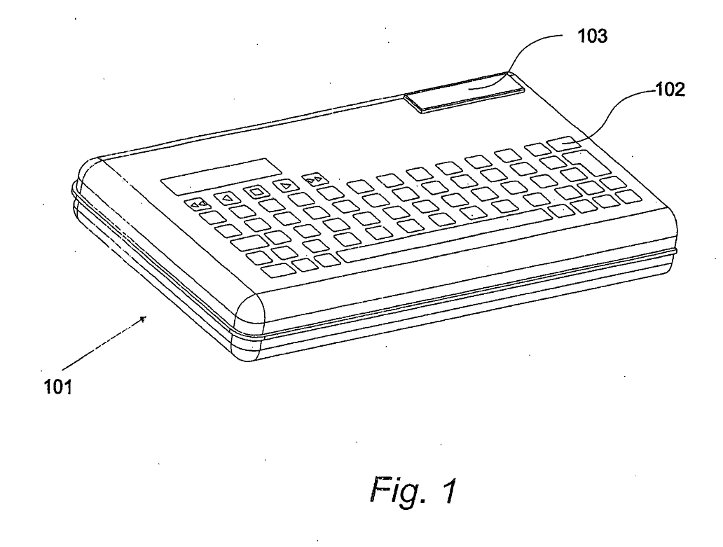

A manually operable data input device is illustrated in FIG. 1 embodied as a fabric keyboard. Flexible fabric keyboards are known, as illustrated in U.S. Pat. No. 6,861,961, assigned to the present assignee. The keyboard 101 is constructed substantially from fabric and has identified key positions 102, which may be printed thereon. An electronic interface device 103 identifies positions at which keys have been depressed and from this produces output data. Output data from the fabric keyboard may then be supplied as to a data processing device, such as a portable computer.

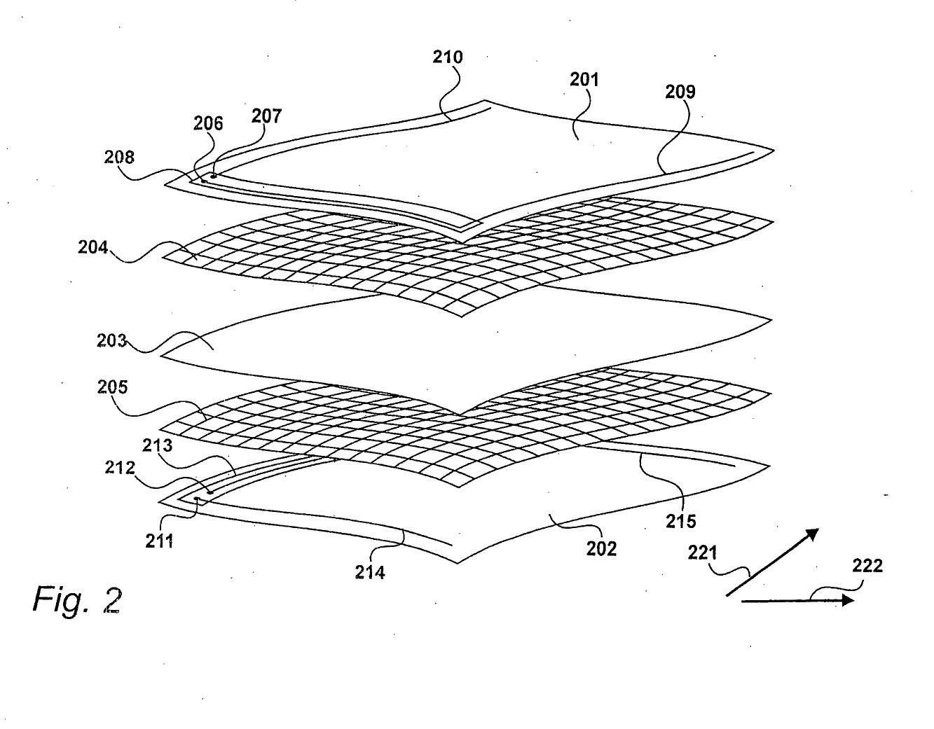

Inner workings of a fabric keyboard illustrated in FIG. 1 are shown in FIG. 2. The data input device utilizes a first fabric layer 201, a second fabric layer 202, and an intermediate fabric layer 203 disposed between the first and second fabric layers 201, 202. Each of fabric layers 201 to 203 is electrically conductive, established by combining insulating fibres with electrically conducting fibres or elements. A first insulating separating layer 204 is disposed between the upper fabric layer 201 and the intermediate layer 203. A second insulating separating layer 205 is disposed between the second fabric layer 202 and the intermediate conductive layer 203. As shown, the first and second insulating separating layers 204, 205 take the form of a mesh.

The first separating layer 204 is configured to separate the upper conductive fabric layer 201 and intermediate conductive fabric layer 203 in the absence of a mechanical interaction with the data input device. However, the first separating layer 204 is penetrable by the upper conductive fabric layer 201 during a mechanical interaction, to allow the upper conductive fabric layer 201 to make electrical contact with the intermediate conductive fabric layer 203.

Similarly, the second separating layer 205 is configured to separate the lower conductive fabric layer 202 and intermediate conductive fabric layer 203 in the absence of a mechanical interaction with the data input device. However, the second separating layer 204 is penetrable by the lower conductive fabric layer 202 during a mechanical interaction, to allow the lower conductive fabric layer 202 to make electrical contact with the intermediate conductive fabric layer 203. Through the intermediate conductive fabric layer 203, a conductive path between the first and second conductive fabric layers 201, 202 can be established at the position of a mechanical interaction with the data input device. The conductive fabric layers may have a weave, knit or felt construction.

Two electrical connectors 206 and 207 are located on a rectangular insulating stripe 208 that is positioned along one edge of upper fabric layer 201. The insulating stripe 208 is produced by printing insulating ink onto the fabric or by applying insulating adhesive tape. The connectors 206 and 207 provide a means of connecting the electronic processing device 103 to lower resistance elements 209 and 210 respectively. The lower resistance elements 209 and 210 are fabricated from fabric coated with a metal, such as nickel or silver, etc. The lower resistance elements 209 and 210 are attached to the conductive fibre layers and the insulating strips by conductive adhesive, such as a pressure sensitive acrylic adhesive containing metallized particles, etc.

The lower fabric layer 202 has a similar construction to the upper fabric layer 201, having connectors 211 and 212 located on an insulating stripe 213. The connectors 211 and 212 provide means for connecting the electronic processing device 103 with low resistance elements 214 and 215, respectively. The lower resistance elements 209 and 210 of upper fabric layer 201 extend along a pair of opposed edges of the fabric layer 201. Similarly, lower resistance elements 211 and 212 of lower fabric layer 202 extend along a pair of opposed edges of the fabric layer 202.

The upper conductive fabric layer 201 includes conductive fibres arranged such that the first conductive layer is conductive in a first direction 221, along the layer. The second conductive fabric layer 202 also includes conductive fibres arranged such that the second conductive layer is conductive in a second direction 222, along the layer. In the exemplary arrangement shown, the first and second directions 221, 222 are substantially perpendicular. Thus, lower resistance elements 209 and 210 are positioned at opposed ends of a conductive path extending in the first direction 221. Similarly, lower resistance elements 211 and 212 are positioned at opposed ends of a conductive path extending in the second direction 222.

The electronic processing device 103 is arranged to apply voltages to and to take measurements from the data input device. When a voltage is applied across the lower resistance elements 209 and 210, a voltage gradient is established across the first conductive fabric layer 201. When a mechanical interaction takes place, the layers are compressed and a conductive path is established between the first conductive fabric layer 201 and the second conductive fabric layer 202. The actual voltage applied to the second conductive fabric layer 202 will depend upon the position of the mechanical interaction along the first conductive path. This voltage can be measured to provide a first positional coordinate of the mechanical interaction. Hence, a potential divider is created and it is possible to determine a position of the interaction in the direction of arrow 221.

Similarly, when a voltage is applied across lower resistance elements 211 and 212, a voltage gradient appears across the second conductive fabric layer 202. When a mechanical interaction takes place, a conductive path is established between the second conductive fabric layer 202 and the first conductive fabric layer 201. The actual voltage applied to the first conductive fabric layer 201 will depend upon the position of the mechanical interaction along the second conductive path. This voltage can be measured to provide a second positional coordinate of the mechanical interaction. A potential divider is hence created and it is possible to determine a position of the interaction in the direction of arrow 222.

With reference to these two voltage measurements, it is possible to identify X-axis and/or Y-axis coordinates of a mechanical interaction within a sensing area. Thus, these two positions then define the position of the interaction on the two-dimensional plane of the keyboard, from which it is possible to identify the specific key that has been pressed. WO 00/72239 A1 discloses a sensor and suitable control circuit operations for determining characteristics of mechanical interactions with the sensor; the entire disclosure of which is incorporated herein by reference in its entirety. WO 00/72239 A1 discloses a sensor for determining x and y coordinate data, along with z data relating to pressure. WO 00/72239 A1 discloses a sensor for detecting force and area of a mechanical interaction separately, along with x and y coordinates of the mechanical interaction.

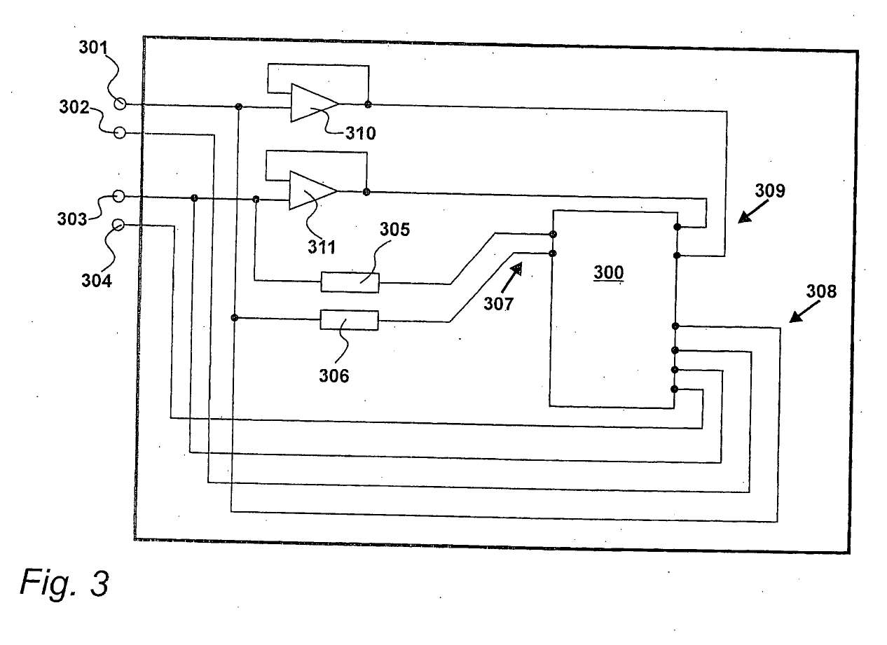

Electronic processing device 103 is detailed in FIG. 3. The processing device includes a microcontroller 300. The processing device supplies voltages to connectors 301, 302, 303, and 304 and provides output values for transmission. Resistors 306 and 307 have a resistance that is substantially similar to the resistance of the fabric detector measured from a first outer conducting layer 201 to the other outer conducting layer 202 when a typical target pressure has been applied. Values in the region of 10 k ohm are typical for these resistors.

A detection process is controlled by a program executed by the microcontroller that is, in turn, configured to supply output voltages at pins 307 and 308 and to receive analogue voltages at pins 309. Input pins 309 receive outputs from high impedance buffers 310 and 311, typically being operational amplifiers of type TL062 operating at half unity gain to provide a high impedance buffer between the output voltages and the microcontroller input ports.

The data input device may be configured to supply input data to a data processing device in accordance with a radio transmission protocol, such as a ZigBee protocol (an implementation of the IEEE 802.15.4 protocol), Bluetooth, Wibree protocol, or other appropriately configured radio transmission protocol. Wibree is designed for ultra low power consumption, operates in 2.4 GHz ISM band with a physical layer bit rate of 1 Mbps, provides link distance of 5-10 meters, and is designed to work side-by-side with and reuse Bluetooth RF part in dual-mode implementations.

The electronic processing device may therefore include a low power consumption radio transmitting device interfaced so as to transmit input data received in response to key presses. The radio transmitting device is accordingly arranged to transmit radio signals to a radio receiving device arranged to receive the transmitted input data.

The processing device may hence include a wireless microcontroller. This may be an IEEE 802.15.4 wireless controller, such as the JN5121 produced by Jennic of Furnival Street, Sheffield, United Kingdom. The microcontroller is a low power IEEE 802.15.4 compliant wireless microcontroller combining an on chip 23 bit RISC core and a fully compliant 2.4 gigahertz IEEE 802.15.4 transceiver, along with 64 kilobytes of ROM and 96 kilobytes of RAM.

The data input device may be enabled to supply input data to a data processing device by means of a mechanical interface, such as a USB computer interface.

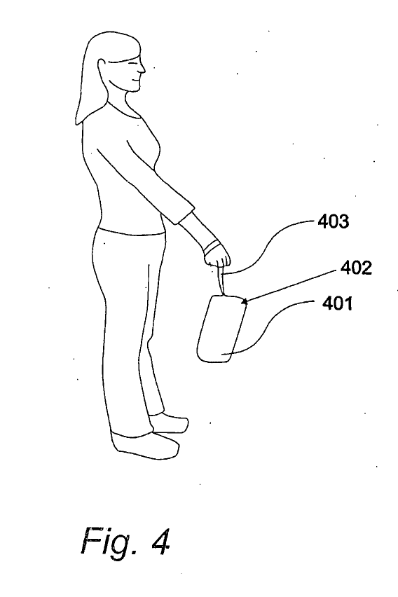

FIG. 4 shows a protective covering for a data processing device, in the form of a rectangular fabric bag 401 with an opening at one of the smaller ends, such as end 402, for receiving the data processing device. The fabric bag 401 may include carrying means, such as carrying strap 403 to facilitate carrying as shown

The protective covering is configured to prevent scratching of the outer surfaces of the data processing device and, in addition, is configured to provide cushioning to prevent impacts adversely affecting the structural integrity of the portable device. As will be described below in further detail, the fabric bag 401 includes a manually operable data input device.

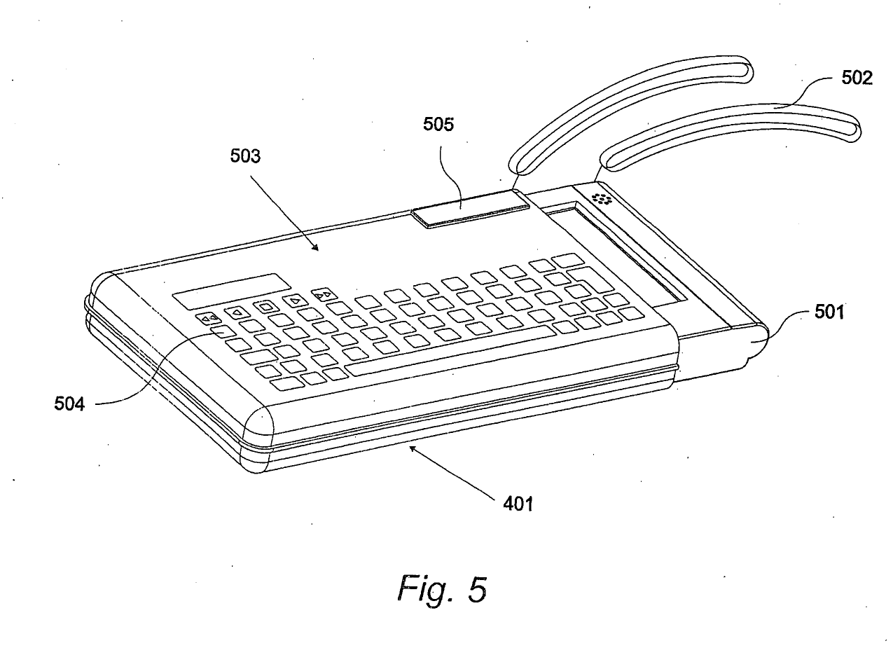

FIG. 5 shows a portable computer 501 partially removed from fabric bag 401, further details of which are also shown. The portable computer 501 may include carrying means, such as carrying strap 502 to facilitate carrying.

The fabric bag 401 presents a fabric surface 503 that is sensitive to the manual application of pressure. In this example, the fabric bag 401 includes a manually operable data input device in the form of a keyboard, such as described with reference to FIGS. 1 to 3 above, including the pressure sensitive fabric surface 503. Key positions, such as position 504, are visibly defined on the fabric surface 503. The fabric bag 401 includes a control circuit, indicated at 505, for identifying mechanical interactions and generating output data in response. The portable computer 501 includes a connection interface and executable instructions for interpreting output data generated by the manually operable data input device.

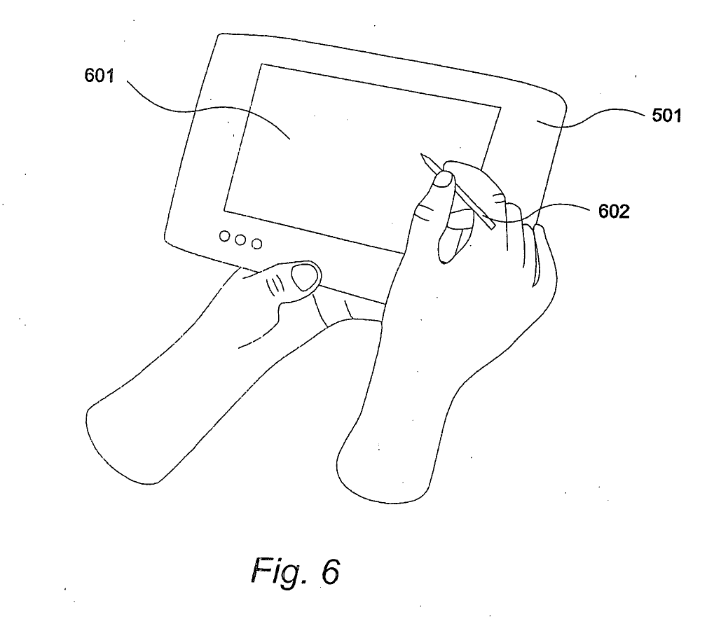

FIG. 6 shows portable computer 501 in further detail. Portable computer 501 is of the type provided with a touch screen 601 as an alternative to a keyboard. The touch screen 601 of portable computer 501 is sensitive to the manual application of pressure. As shown, pressure may be applied by the manual operation of a stylus 602 or similar implement, or by direct application of a finger.

In this example, the portable computer is an ultra mobile PC, of the type that is smaller than a notebook PC but is larger than a personal organiser. In this example, the portable computer is a tablet PC available under the designation Samsung model NP-Q1.

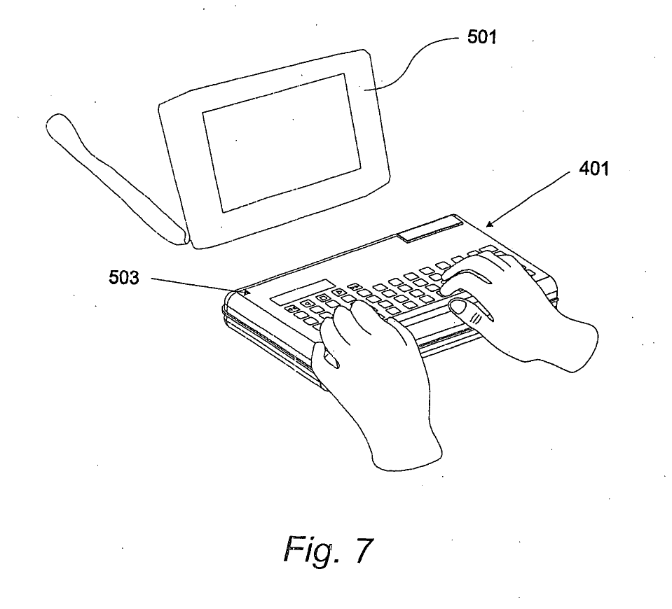

FIG. 7 illustrates the use of fabric bag 401 to generate input data for the operation of portable computer 501. Manual presses at key regions defined on the pressure sensitive fabric surface 503 of fabric bag 401 result in the generation of output data. The portable computer includes a connection interface and executable instructions for interpreting the output data. Thus, portable computer 501 is programmed so as to respond to input data commands.

Output data generated in response to manual pressure applied to pressure sensitive fabric surface 503 of fabric bag 401 may result in a variety of different operations performed by the portable computer 501 in response to input data commands. For example, input data commands may be used to control an executable program, to navigate a menu, to generate text data for visual display, to construct email or text messages, to select a media item for display, and/or to perform editing operations, etc.

The inclusion of a manually operable data input device in the fabric bag provides a convenient method of supplying input data to the portable computer. Although the portable computer may include software to present a visual keyboard that is responsive to pressure applied to the touch screen, the virtual keyboard may be so small that it is impractical for users, in particular those that have impaired vision or dexterity. In addition, an on-screen keyboard may overlie or trigger a reduction in size of a graphical user interface and hence undesirably obscure graphics of interest to the user.

In this example, output data is transmitted from the fabric bag 401 to the portable computer 501 in accordance with a ZigBee radio transmission protocol. Thus, the fabric bag is provided with a radio transmitting device and the portable computer is provided with a radio interface and a radio receiving device.

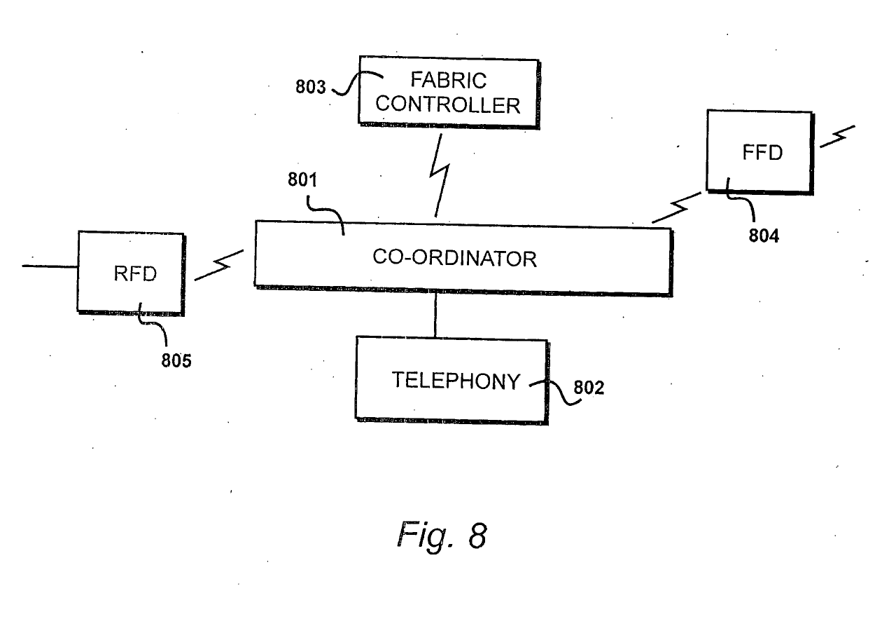

An IEEE 802.15.14 ZigBee environment is illustrated in FIG. 8. At the heart of the network there is provided a ZigBee coordinator 801, which, in turn, operates under the control of a local computer system for performing data processing operations. The coordinator provides a bridge to other networks, such as a telephony network 802, etc. It is also the place where information about the network itself is stored.

The manually operable fabric controller of the fabric bag illustrated in FIGS. 4 to 7 is shown as 803 in FIG. 8 and communicates wirelessly with the coordinator 801. A full function device (FFD) 804 may act as an intermediate router and allows data to be passed from other devices. A reduced function device (RFD) 805 may also be provided within the network.

The ZigBee network uses the IEEE 802.15.4 low rate wireless personal area network standard to describe its lower protocol layers, namely the physical layer and the medium access control portion of the data link layer. In this exemplary embodiment, wireless operation takes place at 2.4 gigahertz using DSSS, which is managed by the digital stream into the modulator. An orthogonal signalling scheme is used that transmits four bits per symbol in the 2.4 gigahertz band to provide a raw over-the-air data rate of 250 kilobytes per channel in the 2.4 gigahertz band. Transmission range is typically between 10 metres and 75 meters. The channel mode access specified by IEEE 802.15.4 is carrier sense, multiple access such that nodes briefly check to see that no one else is transmitting before they themselves start transmitting.

The coordinator 801 is a data processing device configured to produce an output signal. Thus, an output signal may be provided to an application program executed by a local computing facility such that data is received within an operational package, such as a spreadsheet or an email program for example. Alternatively, the data processing device may produce an output signal to a wider network, such as that provided by the telephony functionality 802.

The IEEE 802.15.14 radio environment, and specifically when using the ZigBee protocol, provides a low power consumption radio transmitting device that is interfaced to an input device for transmitting input data.

In relation to the example illustrated in FIGS. 4, 5 and 7, the fabric bag includes the fabric controller 803 and is interfaced to an appropriate node, such as a full function device (FFD) of the type shown at 804. The portable computer includes the coordinator 801 where there is provided a radio receiving device for receiving the transmitted input data, such that the portable computer is interfaced with a radio receiving device.

A manually operable data input device constructed from fabric is configured to receive input data from a user. In the example described so far, the input device takes the form of an alphanumeric keyboard but it should be appreciated that other input devices may be used, such as an alpha pad, a mouse pad, a numeric keypad or an audio player controller, or a combination of different regions providing different functions. The input device may include controls for functions that do not require display on a screen.

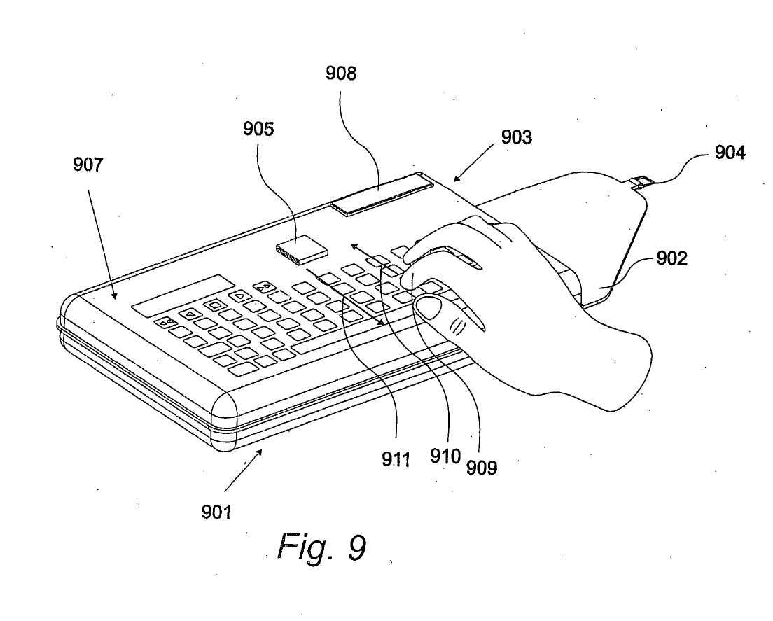

FIG. 9 shows a fabric bag 901 including a manually operable fabric controller for a portable computer. Fabric bag 901 has a flap 902 at the open end 903 thereof, for closing over the opening. The fabric bag 901 is provided with a securing device for the flap 902. According to this illustrated example, a mechanical securing device is provided that has two cooperating components. A first part 904 is provided on the flap 902, in this example at an edge 905 of the flap 902, and a second part 906 provided on the pressure sensitive fabric surface 907 of the fabric bag 901.

The mechanical securing device may include one of various fastenings including a clip, clasp, toggle, button, snap fastener, hook and loop arrangement, combinations thereof, etc.

The control circuit, for generating output data in response to pressure manually applied to fabric surface 907, includes a housing 908, which is in this example located upon the fabric surface 907. In an alternative application, the control circuit is integrated within the fabric assembly of the fabric bag such that it is visibly disguised. In some applications, the control circuit may be removable to facilitate interchanging of connection interface, such as between a wireless connection and a wired connection.

The control circuit of fabric bag 901 is configured to detect the position of a mechanical interaction on fabric surface 907 and is configured to detect the degree of applied pressure. The fabric surface 907 is sensitive to manual presses and to manually applied gesticular movements, including stroke actions, swipe actions, tapping actions, and scrolling actions. Both of these types of mechanical interaction may be used to control operations of a portable computer.

For example, stroking operations across fabric surface 907 may be used to effect menu scrolling. A finger 909 may effect a stroking operation in the direction of arrow 910 to scroll up a list displayed by the portable computer. Thus, the finger 909 is applied to the fabric surface 907 and stroked in an upwards direction. That is to say, movement of the finger 909 in an upwards direction is caused while contact is maintained and held in pressure with fabric surface 907. Similarly, in order to scroll in the opposite direction, down a list displayed on the portable computer, finger 909 is applied to the fabric surface 907 and then moved downwardly in the direction of arrow 911 while remaining in contact, and then removed.

As will be described in further detail below, fabric bag 901 is provided with keys for operation of the computer when the computer is out of the fabric bag 901 and keys for operation of the computer when the computer is in the bag.

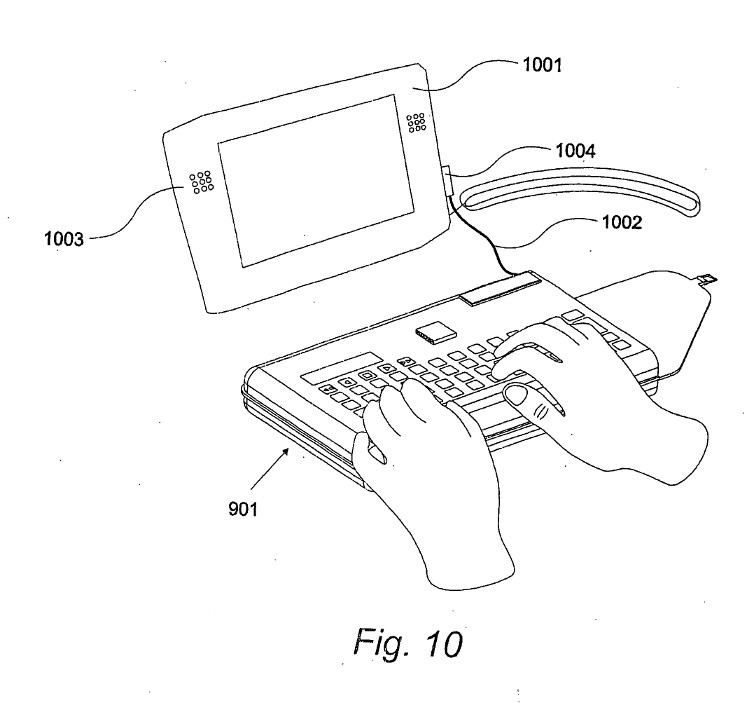

FIG. 10 illustrates the use of fabric bag 901 to generate input data for the operation of a portable computer 1001. Both the fabric bag 901 and the portable computer 1001 are placed upon a substantially flat support surface. As shown, the flap 902 of the fabric bag 901 is open such that all the defined key regions of pressure sensitive surface 907 are exposed.

As previously described, manual presses at key regions defined on the pressure sensitive fabric surface 907 of fabric bag 901 result in the generation of output data. Portable computer 1001 includes a connection interface and executable instructions for interpreting the output data. Thus, portable computer 1001 is programmed so as to respond to input data commands.

In this example, output data is transmitted from the fabric bag 901 to the portable computer 1001 by means of a mechanical interface. A USB connector cable 1002 is provided, which extends between the control circuit housing 908 of the fabric bag 901 and a USB port of the portable computer 1001.

Portable computer 1001 includes audio playback capability. In this example, the portable computer 1001 is provided with speakers 1003 and an interface socket 1004 for stereo headphones, and is configured to provide an audio output signal to the speakers or an earpiece as selected by a user. Such an audio device may work using magnetic tape, magnetic discs, data discs, or solid state storage devices. Portable computer 1001 includes the capability to produce an audio output signal from digital data files, including compressed audio data files such as those identified by the designation MP3. In addition to alpha-numeric and symbolic keys for the operation of portable computer 1001, fabric keyboard 901 includes audio control keys.

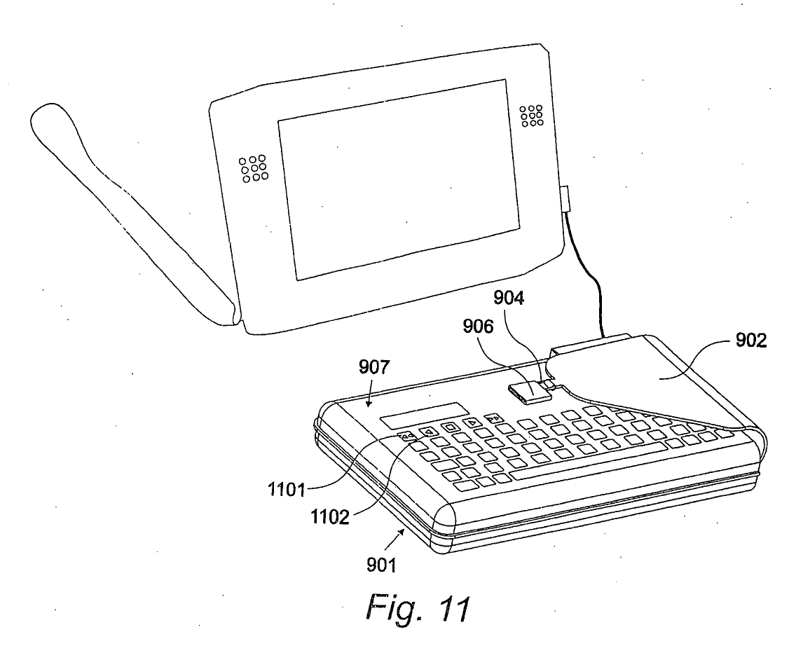

FIG. 11 shows fabric bag 901 with the flap 902 closed. As shown, the first part 904, which is provided on flap 902, is releasably connected to the second part 906, which is provided on the pressure sensitive fabric surface 907 of the fabric bag 901. In the closed position, the flap 902 closes the open small end of the rectangular fabric bag 901 and covers the control circuit housing (908 in FIGS. 9 and 10).

The fabric bag 901 is provided with audio control keys, such as keys 1101 and 1102, for operation of the audio playback capability of the portable computer 1001. Keys may be provided to control a variety of functions or aspects, for example, play, stop, pause, fast forward, rewind, select, and mute.

The fabric bag 901 may include an interface socket (not shown) for stereo headphones, to provide an audio output signal to an earpiece as selected by a user.

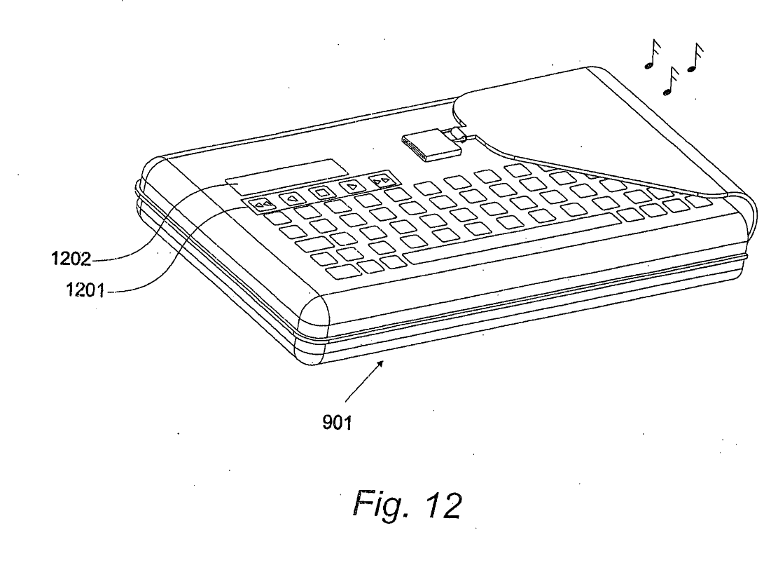

FIG. 12 shows fabric bag 901 in the closed position, with the portable computer in the fabric bag 901. A data connection may be maintained between the manually operable input data device of the fabric bag 901 and the portable computer when the portable computer is in the bag.

In this example, audio control keys, indicated generally at 1201, of fabric bag 901 are responsive to manually applied pressure to control aspects of the audio playback capability of the portable computer when the portable computer is in the bag. As previously described, the fabric surface 907 is sensitive to manual presses and to manually applied gesticular movements.

Thus, manual presses may be used to control discrete operations of the audio playback capability of the portable computer, such as play and stop, whilst gesticular movements may be used to control variable operations of the audio playback capability of the portable computer, such as volume level control and tone control.

As illustrated in FIG. 12, an area 1202 responsive to gesticular movements that is separate to defined key regions may be defined on the fabric surface 907. In other applications, manual presses may control all controllable functions.

Fabric bags as disclosed herein may conveniently provide both a protective covering for a portable computer and also an apparatus and method for supplying input data to the portable computer.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

The description of the disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. Apparatus for covering a portable computer of the type provided with a touch screen as an alternative to a keyboard, the apparatus comprising:
a rectangular fabric bag with an opening at one of the smaller ends of the rectangle for receiving said portable computer;
said bag including:
a fabric surface sensitive to the manual application of pressure;
key positions defined on said surface; and
a control circuit for identifying mechanical interactions to generate output data;
said portable computer including a connection interface and executable instructions for interpreting said output data.

2. Apparatus according to claim 1, wherein said computer is a tablet PC of the type that is smaller than a notebook PC but larger than a personal organiser.

3. Apparatus according to claim 1, including a flap for closing over said opening.

4. Apparatus according to claim 3, including a securing device for said flap.

5. Apparatus according to claim 3, wherein said control circuit includes a housing attached to said fabric surface that is covered by said flap when said flap closes said opening.

6. Apparatus according to claim 1, wherein said fabric surface is sensitive to manual presses and to gesticular movements.

7. Apparatus according to claim 1, wherein said control circuit is configured to detect the position of a mechanical interaction and the degree of applied pressure.

8. Apparatus according to claim 1, wherein said connection interface is a mechanical interface, such as a USB interface.

9. Apparatus according to claim 1, wherein said interface is a radio interface, such as a ZigBee interface.

10. Apparatus according to claim 1, wherein a first surface includes alpha-numeric keys for operation when the computer is out of the bag and audio control keys for operation when the computer is in the bag.
